(19) United States
(12) Patent Application Publication
(10) Pub. No.: US 2015/0315861 A1
(43) Pub. Date: Nov. 5, 2015

(54) WELL OPERATION METHOD AND A WELL OPERATION EQUIPMENT SYSTEM FOR HANDLING A CONTINUOUS ELONGATE DEVICE TO BE INSERTABLE INTO A WELL

(71) Applicant: Stimline AS, Kristiansand (NO)

(72) Inventors: Erik ZACHARIASEN, Kristiansand (NO); Mads BJØRNENAK, Kristiansand (NO)

(73) Assignee: Stimline AS, Kristiansand (NO)

(21) Appl. No.: 14/491,657

(22) Filed: Sep. 19, 2014

(30) Foreign Application Priority Data
Apr. 30, 2014 (NO) 20140562

(51) Int. Cl. E21B 19/22; B60P 1/04; E21B 19/00; E21B 19/083; E21B 15/00; E21B 17/20

(52) U.S. Cl. CPC E21B 19/22; E21B 15/006; E21B 17/20; E21B 19/008; E21B 19/083; E21B 15/003; B60P 1/04

(57) ABSTRACT

A well operation method and system for handling a continuous elongate device (CED) (28), such as e.g. coiled tubing, rod, wire or wireline, to be inserted into and retracted from a well (35), comprising: transporting to a well site (35) by a first trailer (21) a movable work platform (23) having a tiltable mast (24) and a CED conveyor apparatus (25, 26) linked to a free end of the mast, deploying at least four legs or outriggers (30-33) out from a platform circumference, lifting the work platform (23) up from and off engagement with the first trailer (21) by means of said legs or outriggers (30-33), moving the trailer (21) away from the work platform (23), transporting a CED reel (29) to a rear end (23″) of the work platform (23) by means of a second trailer (21), causing arms (27) at the rear end (23″) of the work platform (23) to engage the CED reel, lifting the CED reel (23) off the trailer, and bringing the CED (28) in engagement with the conveyor apparatus (25; 26) and a lubricator string (42), wellhead (36) and a well (35).

### FIELD OF THE INVENTION

The present invention relates to a well operation method for handling a continuous elongate device (CED), such as e.g. coiled tubing, rod, wire or wireline, to be inserted into and retracted from a well.

Further, the present invention relates to a well operations equipment system for handling a continuous elongate device (CED), such as e.g. coiled tubing, rod, wire or wireline, to be inserted into and retracted from a well, the system, as defined in the preamble of attached claim 1, comprising: a movable work platform,
a tiltable mast which is configured to extend or be extendable with inclination up from a front region of the work platform, and
   a CED conveyor apparatus linkable or linked to a free end of the mast.

Such CED is movable through a conveyor apparatus, to enable insertion of tools through a well and into a well below, or retraction from the well up through the conveyor apparatus by pulling action to enable retrieval of such tools from the wellhead and the well below.

Suitably, there is located lubricator string sections between the conveyor apparatus and the wellhead.

Such a conveyor apparatus is frequently called an “injector head” in this particular field of use.

The wellhead is primarily meant for oil and natural gas exploration and production operations.

Particularly, the present invention relates to improvements related to land based operations, in particular for in a more convenient manner being able to move the required operational apparatus from one well to a neighbouring well more quickly and with less efforts and expense, both as required man-hours and use of required equipment for the movement.

It is well recognized in the prior art that a plurality of motorized, expensive vehicles with experienced drivers and operators are required for such operations, and with the motorized vehicles being left in an idle state during the well operations. Further, the prior art solution requires an extra amount of space which may not always be readily available at a drilling site.

In the description and claims, the general term CED, i.e. Continuous Elongate Device, will be used, implying that the CED may be interpreted as being a continuous tubing (e.g. coiled tubing), continuous rod or interconnected rod sections, continuous wire or continuous wireline. In case of rods or rod sections, they could e.g. be massive rods of metal, metal alloys, carbon material and/or fiber reinforced plastic material.

However, in the discussion to follow it will mostly be referred to use of continuous tubing as a practical example of CED.

### TECHNICAL BACKGROUND OF THE INVENTION

Use of CED's, such as e.g. coiled tubing, sourced from a hydraulically operated reel is known in oil and natural gas exploration and production operations. These tubings, generally refer to metal pipes, e.g. made from steel, with diameter e.g. ranging between 1 inch and 4 inches (2.54-10.12 centimeters), or suitably e.g. within the range 1.5 to 3.5 inches (3.81-8.89 centimeters). Other diameters, smaller or larger may be used. Such tubing may typically have a wall thickness of 5-15% of the tubing diameter, although a different wall thickness range may applied dependent on the use of the tubing. It is also known, that coiled tubing can perform many different oil well operations, and these include use in interventions in oil and gas wells, and also use as production tubing in gas wells.

Application of such coiled tubing in oil and gas operations involves deploying the tubing as support for drill tools for inserting those tools into boreholes or for retrieving those tools from boreholes. Such tools can be packers, valves, sleeves, sensors, plugs, gauges and so on, which have to be run into and retrieved from the boreholes. These tools may find use for servicing the well.

The operations as stated in the preceding paragraph are performed through lubricator string sections and those sections serve as a sluice for undertaking such operations, as well as serving to some extent to counteract the weight of the CED which is inserted into the well, as the weight of the lubricator string sections is substantially on a BOP (Blow Out Preventer) and the wellhead below.

How a lubricator string functions for insertion of tools into the well and for retrieval of the same therefrom, are all common knowledge in the art and will not be elaborated on any further.

How to handle a tubular piping system is e.g. described in Norwegian Patent Application Nr. 20131601. Additional details are described in Norwegian Patent Applications Nr. 20140092 (filed on 28 Jan. 2014).

In the above context, telescopic injector head supporting masts are also known which extend from a base up to a substantial height and supports a coiled tubing conveyor apparatus (injector head) at its top end and a lubricator string at its top linked to the conveyor apparatus. Upon insertion into the well head, prior thereto coiled tubing is stabbed through the coiled tubing conveyor apparatus, and thereafter conveyed through the lubricator string, which is located just above the borehole. The purpose is to insert tools into the borehole as stated before. The pulling operation of coiled tubing takes place in just the opposite direction when retrieving the tools from the borehole.

As stated before, injector head masts for ensuring lifting of tubing conveyor apparatus (injector heads) to undertake the operation as stated in the preceding paragraph are already known. For example, U.S. Pat. No. 7,077,209 teaches a telescopic mast having two arms, which can telescopically rise for supporting a tubing or CED gripper conveyor apparatus at a height and positioning it above the wellhead. The mast is pivotally mounted to a vehicle.

Norwegian Patent Application Nr. 20131640 describes a handling system as shown on FIG. 1.

FIG. 1 is a view of the basic layout of the prior art handling system 1 in which a conveyor apparatus 2 or injector head 2 is present. The handling system 1 comprises an injector carrying mast 3, which is telescopic. The mast 3 and a tubing guide arch 4 are operatively linked to a supporting cage 5 of the apparatus 2 at a top region of the mast 3. This support cage 5 can be moved, e.g. rotated, to ensure alignment of the injector head 2 above a wellhead 6 and also for ensuring smooth feeding of coiled tubing 7 through a lubricator string 8. Movement of the cage 5 can be assisted by hydraulic, pneumatic or electrical drive means.

Apart from being telescopically adjustable, the mast 3 can also be caused to swivel. The mast 3 is supported from below on a mast truck 9. The truck 9, at its rear end has a carrier 10 for parking a BOP (Blow Out Preventer) unit 11, when this unit is not in use. The rear portion of the injector head mast truck 9 also has a rigging winch 12 and a sheave (not shown) for stabbing/pulling coiled tubing 7 through the conveyor apparatus/injector head 2 when it is “empty”, i.e. not yet fully engaging the tubing 7 over a full conveying length of the apparatus 2. The guide arch 4 facilitates this stabbing/pulling operation of coiled tubing 7 through the injector head 2, an operation where the aid from the winch 12 is highly required in view of a substantial drag force action on the tubing in the opposite direction of the pulling/stabbing.

It should be also clear from FIG. 1 that a rear face of the mast 3 is adjacent the injector head 2. This rear face is suitably equipped with a handling device 13 for the lubricator strings 8. The handling device 13 allows accurate, rapid and safe assembly and disassembly of the lubricator string sections 8′ on and from the top of the wellhead 6.

FIG. 1 also shows a hydraulic power unit 14 located along the chassis of the truck 9. The operations are mostly hydraulically powered and this unit supplies hydraulic pressurized fluid to numerous hydraulic actuators (not shown on FIG. 1) used in the handling system. In addition FIG. 1 shows a reel truck 15 and the reel trailer 16 which are well known to persons skilled in the art. The coiled tubing/CED 7 is supplied from a reel 17 located on the trailer 16. The release from or winding of tubing onto the reel 17 is assisted and facilitated by a tubing tensioner 18 which is hydraulically powered by an hydraulic unit 19 at the rear portion of the reel trailer 16. The central portion of the reel truck 15 has a control room 20.

The mast 3 and the reel 17 (drop-in type) can also rest on other platforms, such as fixed structures, as known to persons skilled in the art.

The mast 3 is of telescoping type or a combination of folding plus telescoping type. The mast has one telescope section for simplicity, however additional sections are possible if required. The mast cross section is suitably of self-centering type.

Expected maximum height from ground to the cage 5 is approximately 20 meters. The mast 3 extends from its base on the truck 9 and lifts the injector head 2 supported by the cage 5. The injector head 2 includes the carrying cage 5 and the tubing guide arch 4 is mounted onto the top of that cage 5, and the cage 5 is attached to the top of the mast 3.

The cage 5 can be tilted hydraulically relative to the mast 3 to enable the cage 5 to be positioned vertically as the mast 1 is angled, to thereby align the injector head 2 and its cage 5 with a center line of the well head 6 and the well below (not shown).

The guide arch 4 can be rotated relative to the cage 5 from a first operational position through 180° to a second operational position. However, the cage 5 can be rotated relative to the mast 3 to accept coiled tubing 7 (or CED) from the reel 17 from any desired direction around the mast 3, depending upon the location of the reel 17.

In the prior art related to pad well operations, the number of pad drilling operations on shale gas/oil wells on land is increasing. Pad drilling implies that drilling contractors drill a series of wells in a row, typically 7-15 meters between the wells. Conventionally, there may be 10 to 30 wells in a row.

The current way of performing coiled tubing operations on pad drilling is that a coiled tubing unit is assembled and operated on each well, then rigged down, moved 7-15 meters, and is then is rigged-up again. This process is very time consuming, as it may take from 3 to 24 hours.

A pad well type drilling rig is known as Patterson—UTI Drilling Rig 263 which is currently operating in the Marcellus Shale region in Pensylvania, USA, and is a new pad well drilling rig generation of APEX-XK rig structure designed for more clearance in sub-structure to accommodate a walking system. According to information, the rig is able to walk in any direction from well to well in approximately 45 minutes with all piping racked in the rig derrick.

Other prior art rig structures suitable for moving an operating rig or platform from one location to another are known from e.g. WO2013/123221, GB 882,911 and U.S. Pat. No. 3,255,836. Other platform or vehicle moving systems are inter alia known from U.S. Pat. No. 4674949, U.S. Pat. No. 4,202,423, EP 0,157.633 and U.S. Pat. No. 3,612,201. In general, for moving drilling rigs for pad well drilling, well known walking systems known as “Walking Beam Systems” may be used. Examples of these prior art systems are inter alia found at multiple Internet websites.

### OBJECTS OF THE INVENTION

As indicated by the prior art depicted on FIG. 1, there is a necessity to have at least two motorized vehicles or trucks 9 and 15 present at the well site in order carry and move the required equipment of the prior art system to and from a well, as well as from one well to a next one not being far away, if required. This implies that expensive, space demanding equipment will have to be at the well site at all times during well operations, adding to the overall cost for such operations. In addition, such expensive transport equipment will be left idle at the drilling site while well operations are in progress at a specific well.

It is therefore a principal object of the present invention to provide a handling system which is simpler and easier to use, and enabling movement of the required operational equipment of the system from one well to another neighbouring well without requiring assistance from expensive trailers and trucks. Thus, the inventions aims at providing a more cost-effective and practical technical solution.

The invention will be primarily intended for “from well to well” use, i.e. pad well operations. It may conveniently be used for single well interventions if so required, although it is not so flexible for such option.

More specifically, the invention is in general intended to provide remedies in order to substantially overcome the disadvantages which are well known from the current prior art.

Among the intended objects of the invention are to:
provide an efficient multi-well coiled tubing unit;
avoid swing loads over nearby wells;
be able to serve work platforms (pads) of any required length;
rig-up at well location in less than 2 hours for the system to be operative;
moving the operational system from one well to a next in less than 20 minutes, plus time for disconnection and connection of BOP.
enable mobilization of system equipment using standard transport equipment, such as conventional trucks and standard trailers, e.g. “lowboy” trailer, and
replace conventional intervention crane by an optimized mast.

### SUMMARY OF THE INVENTION

According to the invention, the present method comprises:

transporting to a well site by a first trailer a movable work platform having a tiltable mast and a CED conveyor apparatus linked to a free end of the mast, deploying at least four legs or outriggers out from a platform circumference, lifting the work platform up from and off engagement with the first trailer by means of said legs or outriggers,
moving the trailer away from the work platform,
transporting a CED reel to a rear end of the work platform by means of a second trailer,
causing arms at the rear end of the work platform to engage the CED reel, lifting the CED reel off the trailer, and
bringing the CED in engagement with the conveyor apparatus and a lubricator string, wellhead and a well.

In an embodiment of the method, the work platform when resting on its legs or outriggers on a land surface is moved from one pad well to an adjacent pad well by means of walking beams system feet, movement being available in any one of its sideways directions, its longitudinal directions and its rotation about a rotation axis commonly defined by the legs or outriggers.

In a further embodiment of the method, feet of the platform legs or outriggers define corners of a polygon on a ground surface on which the work platform is located by means of the legs or outriggers, and centre of gravity of system equipment, composed of the work platform, the mast, the conveyor device, the CED between the reel, the conveyor device and the well, the reel, and CED on the reel, is located inside the perimeter of the polygon.

According to the invention, the present system exhibits features of:

the work platform having from a rear region thereof a pair of rearwards extending CED reel lifter and reel retainer arms configured to handle a CED reel, and
the work platform having at least four legs or outriggers deployable out from its circumference.

In this context, it will be recalled that CED is a continuous elongate device, such as e.g. coiled tubing, rod, wire or wireline.

In a further embodiment of the system, the work platform is configured to be releasable held and be transportable in its longitudinal direction to and from a well site by means of a trailer, and the work platform is able to be lifted up from or down into engagement with the trailer by means of said legs or outriggers.

In another embodiment, the work platform when resting on its legs or outriggers on a land surface is movable from one pad well to an adjacent pad well by means of walking beams system feet, movement being available in any one of its sideways directions, its longitudinal directions and its rotation about a rotation axis commonly defined by the legs or outriggers.

In a preferred embodiment, the CED reel is movable to a platform location by means of a trailer on which the reel can rest, and the CED reel is configured to be moved from engagement with the trailer and into engagement with the reel lifter and retainer arms on the platform.

In a still further embodiment, the CED reel is movable into engagement with said arms by means of a trailer on which the reel can rest by means of reel legs, and wherein the CED reel is configured to be lifted off the trailer by lifting action from said CED reel lifter and retainer arms using hydraulic cylinders located on the platform and acting on the arms.

In a variant thereof, the CED reel is movable into engagement with said arms by means of a trailer on which the reel can rest by means of reel legs, and the CED reel is configured to be lifted off the trailer by lifting action from said reel lifter and retainer arms using lifting power from hydraulic cylinders acting between an outer location of the legs or outriggers and their feet.

In still another embodiment, a CED tensioner device is located above the reel or at a rear end of the platform adjacent a forward region of the reel and above highest level of the reel. Suitably, the tensioner device is associated with a tensioner drive motor enabling the tensioner to move reciprocally in axial direction of the reel, and a CED passage length counter.

In an embodiment related to movement of the platform, the feet of the platform legs or outriggers define corners of a polygon on a ground surface on which the work platform is located by means of the legs or outriggers, and centre of gravity of system equipment, composed of the work platform, the mast, the conveyor device, the CED between the reel, the conveyor device and the well, the reel, and CED on the reel, is located inside the perimeter of the polygon.

In another embodiment related to movement, an outer location of the legs or outriggers define a movement circle about the centre of which the platform can be rotated, the feet at the outer location being configured for both walking and support of the work platform.

### BRIEF DESCRIPTION OF THE DRAWINGS

Having described the main features of the invention above, a more detailed and non-limiting description of non-limiting embodiments of the well operation equipment system according to the invention and aspects thereof is given below, with reference to the attached drawings.

FIG. 1 is an overview of a prior art handling system.

FIG. 2 is a perspective view of a trailer attached to a truck, the trailer carrying a work platform in a collapsed state with a mast in downwardly tilted state, and a CED conveyor/injector head with associated CED guide arch attached to an end of the mast.

FIG. 3 is another perspective of the trailer and its load as shown on FIG. 2.

FIG. 4 is a perspective view from above and said one side as shown on FIGS. 2 and 3, with the work platform unfolded and with legs or outriggers in deployed state, and the platform lifted off the trailer.

FIG. 5 is a perspective view showing the view of FIG. 4, however with the truck and trailer driving away from the work platform.

FIG. 6 is a perspective view of the work platform, the associated mast, CED conveyor/injector head/guide arch of FIGS. 2-5 with no truck and trailer present.

FIG. 7 is a perspective view as shown on FIG. 6 with the mast in an upright position with the CED conveyor/injector head/guide arch at its top.

FIG. 8a is a perspective view of a trailer attached to a truck and carrying a CED reel having legs resting on the trailer.

FIG. 8b is a side view of FIG. 8a.

FIG. 9 is a perspective view showing the trailer on FIGS. 8a and 8b moving partly under the work platform.

FIG. 10 is a perspective view showing the view on FIG. 9 with the CED reel in position lifted off the trailer and carried by arms on the work platform.

FIG. 11 is a side view of the work platform with its legs/outriggers, the mast in tilted position and with the CED conveyor/injector head/guide arch to engage CED coming from the CED reel.

FIG. 12 is a perspective view from above of the view of FIG. 11.

FIGS. 13 and 14 are perspective views of the work platform, the mast in upright position, the CED conveyor/injector head/guide arch forwarding the CED coming from the CED reel into a lubricator section and into a pad well via a BOP.

FIGS. 15 is a side view of FIGS. 13 and 14.

FIG. 16 is a view from above of FIGS. 13-15.

### DETAILED DESCRIPTION OF THE INVENTION

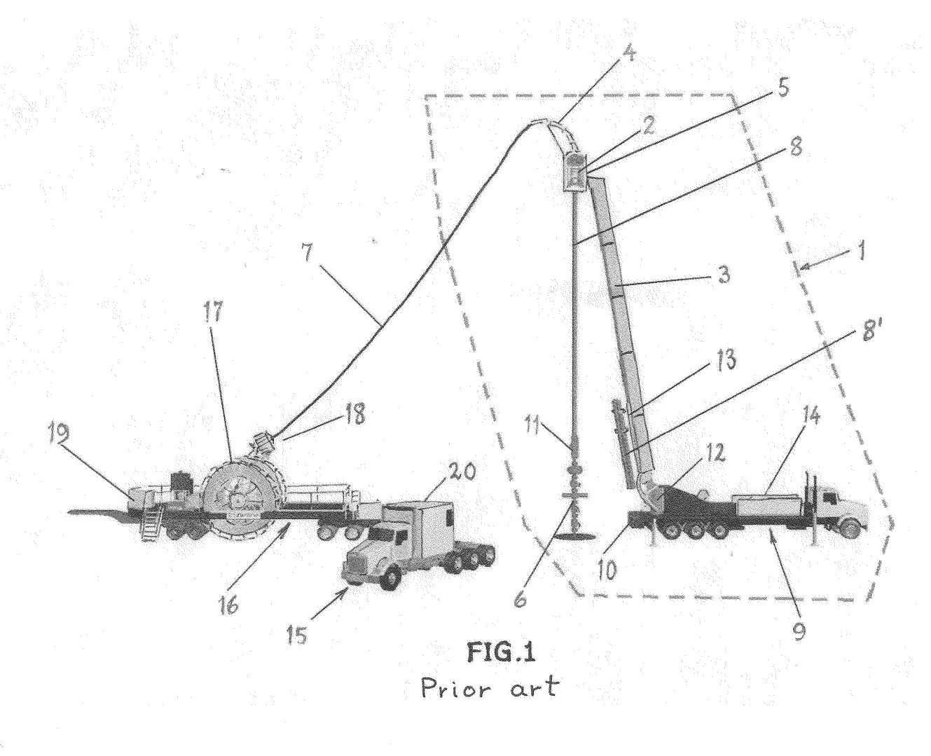

FIG. 1 is an overview of a prior art handling system which has been described in the introductory part of the specification.

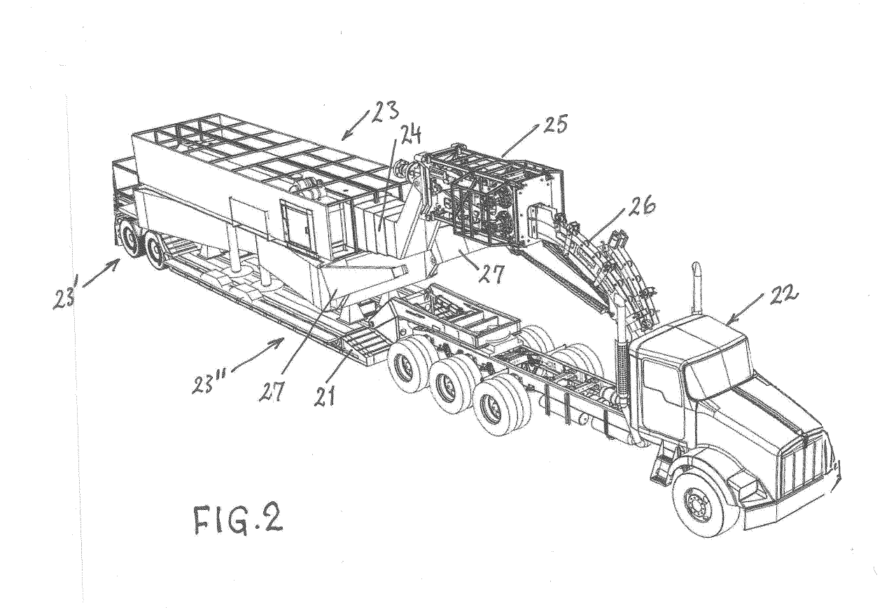

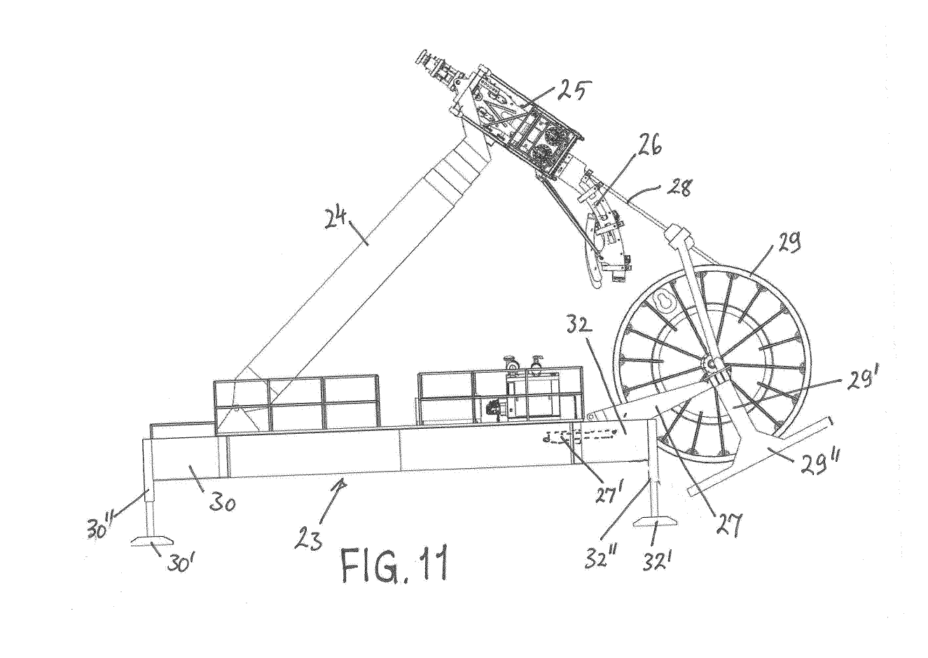

FIG. 2 is a perspective view of a trailer 21 attached to a truck 22, the trailer carrying a movable work platform 23 which on FIG. 2 is in a collapsed state with a mast 24 in downwardly tilted state, and a CED conveyor/injector head 25 with associated CED guide arch 26 attached by a link to a free end of the mast 24. In the context of the present inventive well operation equipment system, the CED denotes a continuous elongate device 28, see e.g. FIG. 11, such as e.g. coiled tubing, rod, wire or wireline, to be inserted into and retracted from a well. The tiltable mast 24 is configured to extend or be extendable with inclination up from a front region 23′ of the work platform 23.

The tiltable mast is suitably of a telescopic type, in order that its length conveniently may be adjusted in order to position the CED conveyor/injector head 25 vertically above a well. However, a mast of fixed length is also possible.

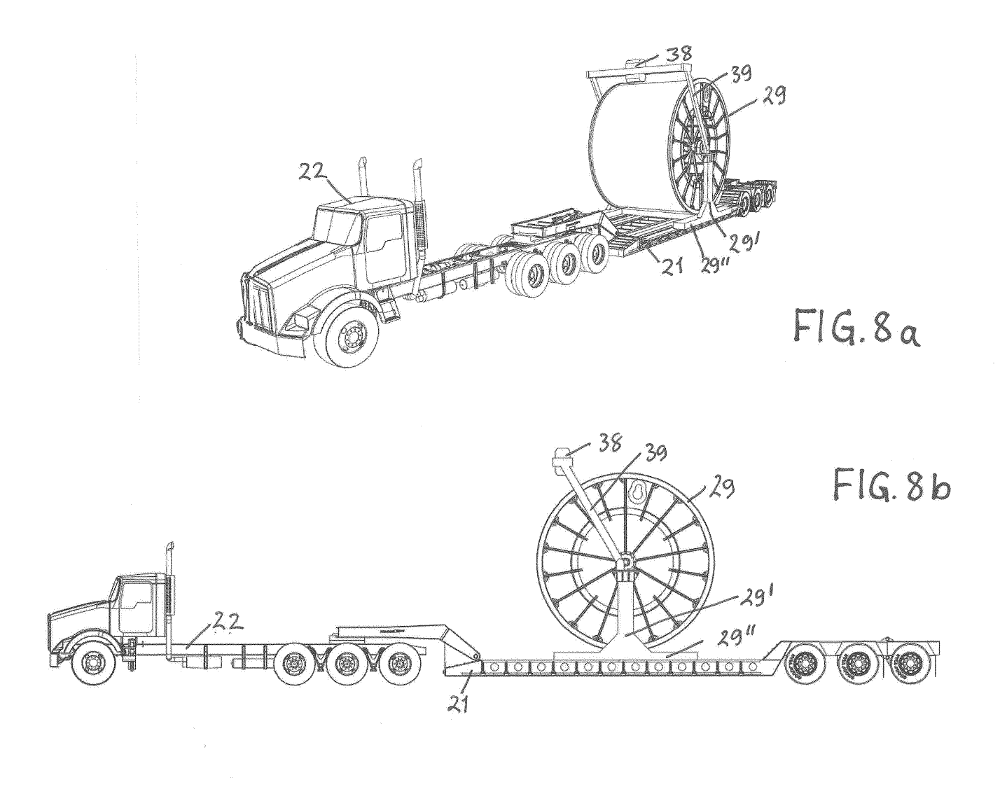

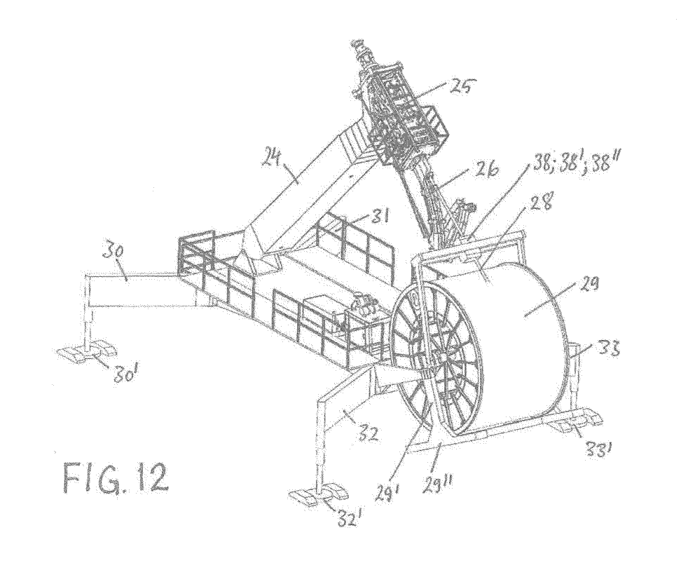

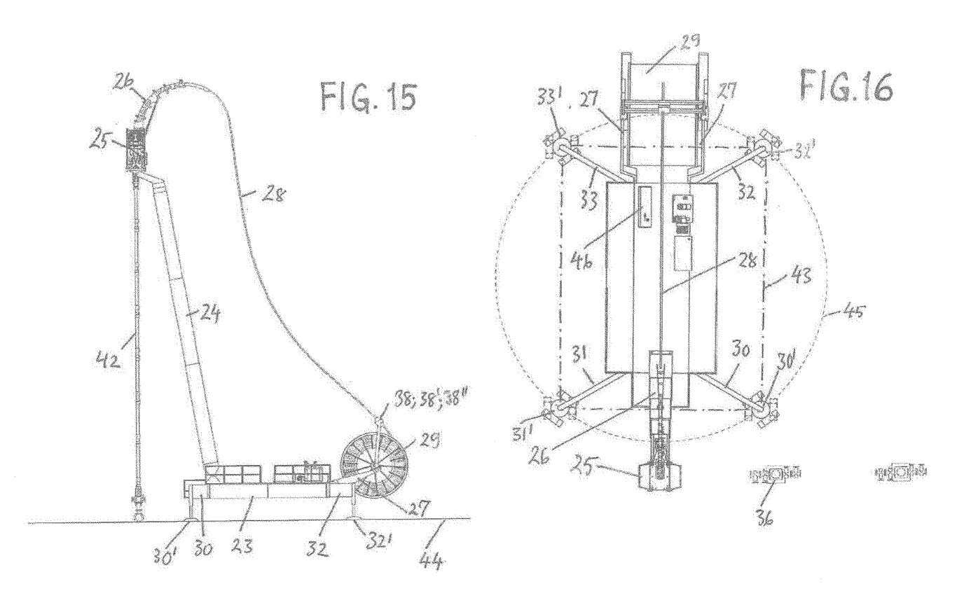

The work platform 23 has from a rear region 23″ thereof a pair of rearwards extending CED reel lifter and reel retainer arms 27 configured to handle a CED reel 29, see FIGS. 8a, 8b and 9-16.

The work platform 23 has at least four legs or outriggers 30-33 deployable out from its circumference. It is noted that the each leg or outrigger has a foot 30′-33′ which is suitably of a “walking beam” type, enabling both walking and support of the work platform 23.

The work platform 23 is configured to be releasable held and be transportable in its longitudinal direction to and from a well site by means of the trailer 21. The work platform 23 is able to be lifted up from or down onto engagement with the trailer by means of said legs or outriggers 30-33 in interaction with their feet 30′-33′ and using hydraulic cylinders 30″-33″ between the legs/outriggers 30-33 and said feet 30′-33′

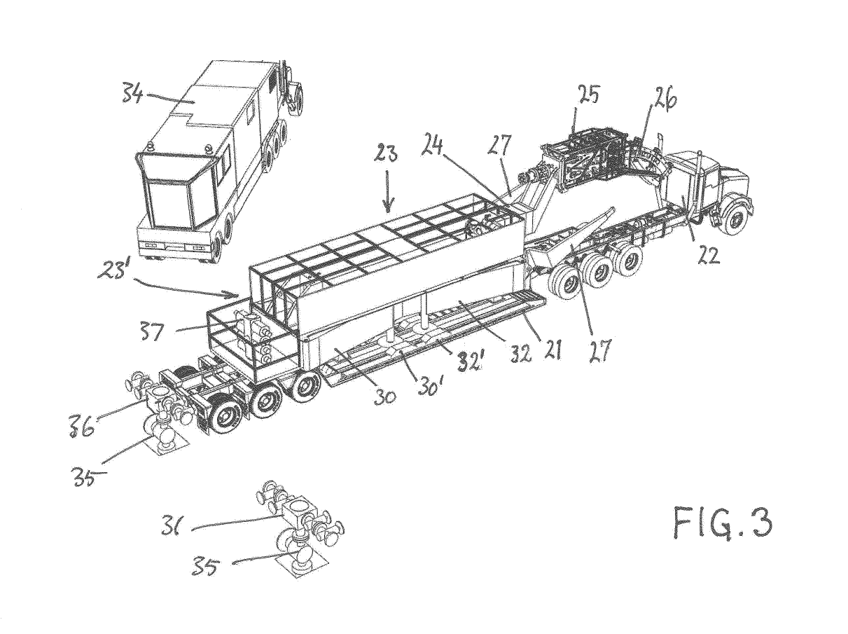

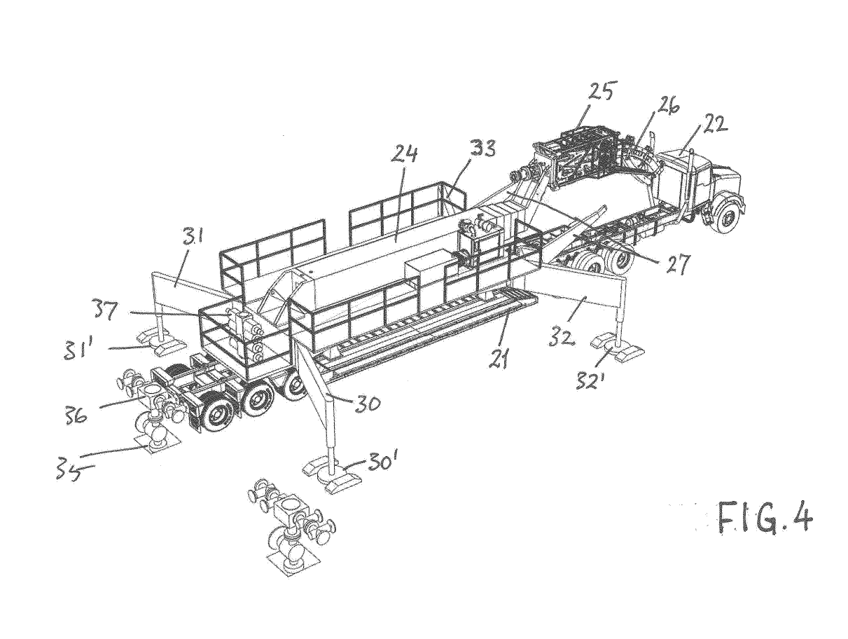

In order to adapt the width of the load carried by the trailer to a narrow width of a road, the work platform 23 needs to be in a folded state as seen on FIGS. 2 and 3. FIG. 4 shows the work platform unfolded and with the legs or outriggers 30-33 in deployed state, and the platform lifted off the trailer 21.

The work platform 23, when resting via its legs or outriggers on a land surface, is movable from one pad well 35 to an adjacent pad well by means of the walking beams system feet 30′-33′, movement being available in any one of: its sideways directions, its longitudinal directions and its rotation about a rotation axis commonly defined by the legs or outriggers.

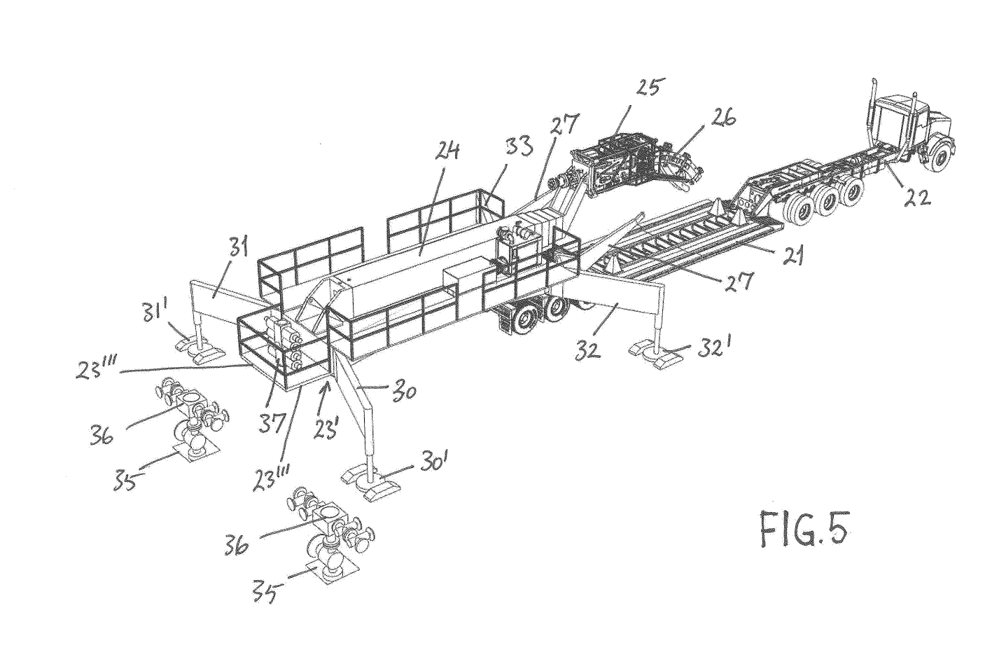

FIG. 5 shows the truck 22 and trailer 21 driving away from the work platform. The same truck 22 and trailer 21 may be used for collecting at a remote place and delivering to the platform arms 27 the CED reel 29, or a different truck and trailer may be used.

An operations control vehicle 34 is shown on FIGS. 3, 6, 7, 9 and 10 and is present to control well operations, and inter alia provide any remote control of the platform 23, the CED conveyor/injector head 25, inclination and/or length of the mast 24.

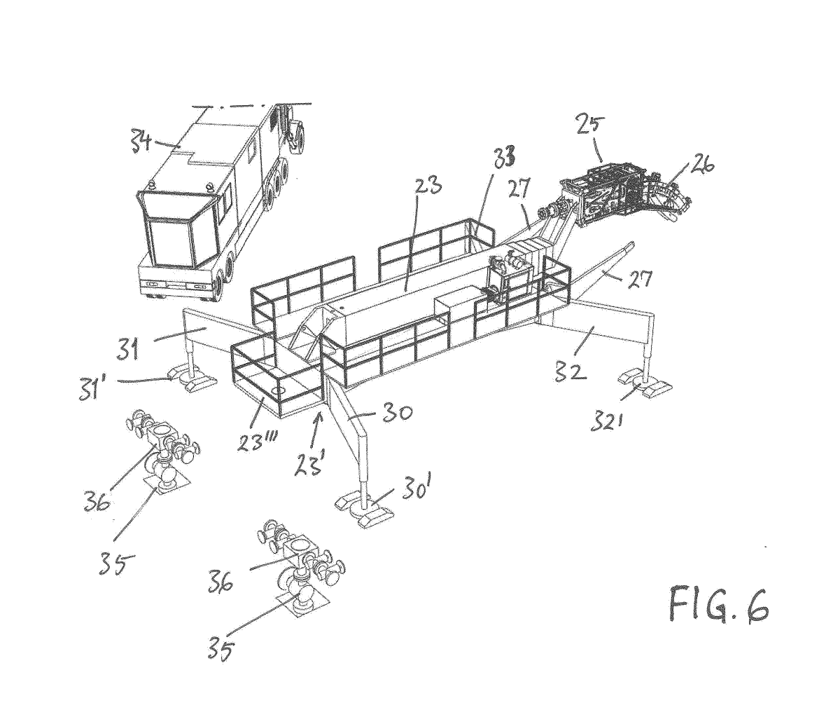

FIG. 6 is a perspective view of the work platform, the associated mast, CED conveyor/injector head/guide arch of FIGS. 2-5 with no truck and trailer present.

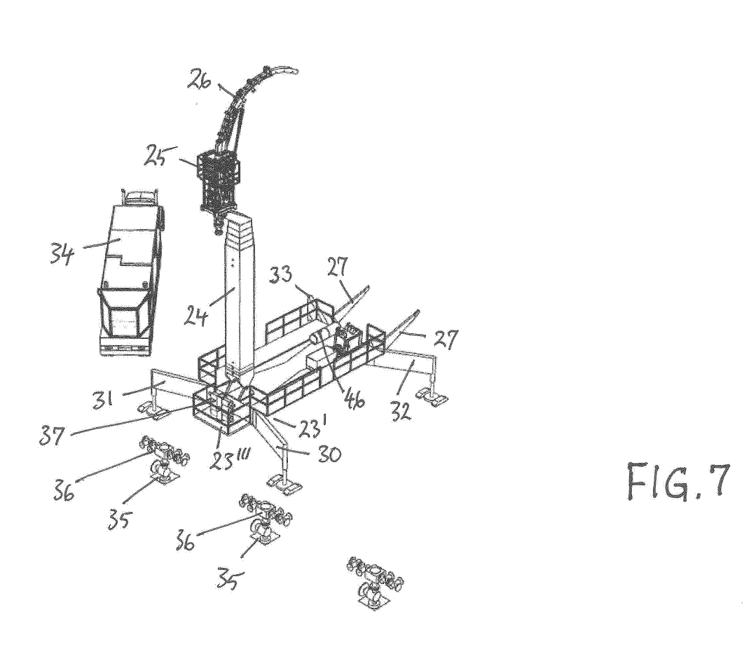

FIG. 7 shows the mast 24 in an upright position with the CED conveyor/injector head/guide arch 25, 26 at its top. It is noted that the platform 23 at its end 23′ facing a well 35 with wellhead 36 has a platform part 23″′ on which the BOP 37 can be placed when not in use. To avoid sideways forces, the BOP (Blow Out Preventer) is landed on the work platform part 23″′ during travel. On a pad move, nothing is disconnected from the well head 36 other than the BOP 37.

FIGS. 8a and 8b show a trailer 21 attached to a truck 22 and carrying a CED reel 29 having legs 29′ resting with the feet 29″ thereof on the trailer.

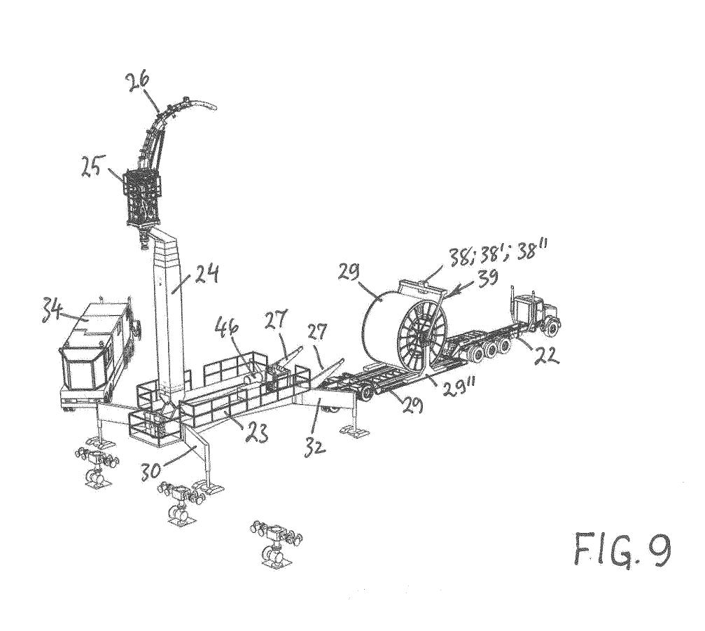

FIG. 9 is a perspective view showing the trailer on FIGS. 8a and 8b moving partly under the work platform. The CED reel 29 is thus movable to a platform location by means of the trailer 21 on which the reel can rest, and the CED reel 29 is configured to be moved from engagement with the trailer 21 and into engagement with the reel lifter and retainer arms 27 on the platform 23.

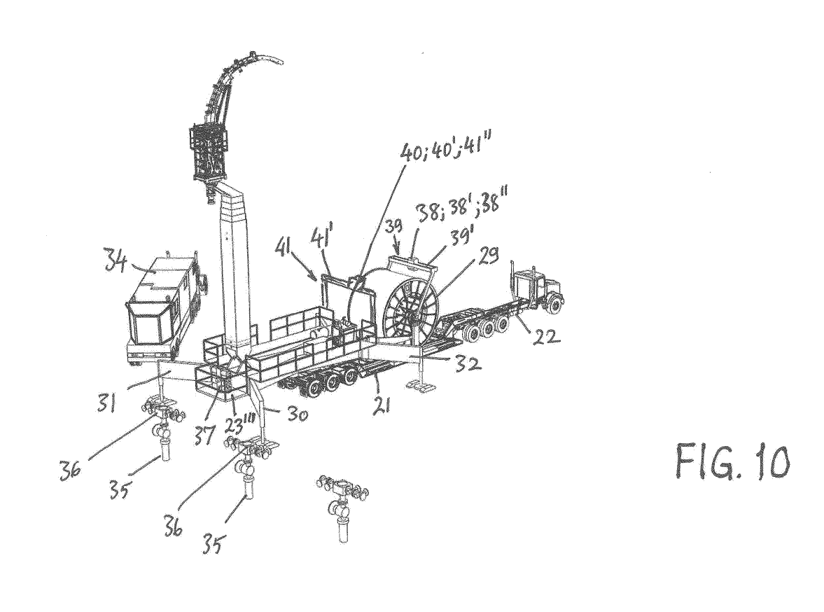

FIG. 10 is a perspective view showing the view on FIG. 9 with the CED reel 29 in position lifted off the trailer 21 and carried by the arms 27 on the platform. Thus, the CED reel 29 is movable into engagement with said arms 27 by means of the trailer 21 on which the reel 29 can rest by means of said reel legs 29′ and their respective feet 29″.

In a currently preferred mode of operation, the CED reel 29 is configured to be lifted off the trailer 21 and onto said arms 27 by lifting action from said reel lifter and retainer arms 27 using hydraulic cylinders 27′ located on the platform and acting on the arms 27, see FIG. 11. However, in a variant, the CED reel 29 is configured to be movable into engagement with said arms 27 by means of the trailer 21 on which the reel 29 can rest by means of its reel legs 29′ and feet 29″, and the CED reel 29 is in this case configured to be lifted off the trailer 21 by lifting action from said reel lifter and retainer arms 27 using lifting power from hydraulic cylinders 30″-33″ acting between an outer location of the legs or outriggers 30-33 and their feet 30′-33′. Other approaches in order to move the reel 29 off engagement with the trailer 21 and into engagement with the arms 27 will be obvious to an expert in the art.

FIG. 8a-16 depict a CED tensioner device 38 which is located above the reel 29 on a frame 39 or alternatively, as indicated by references 40; 41 on FIG. 10 at a rear end 23″ of the platform 23 adjacent a forward region of the reel 29 and in any case above highest level of the reel 29. The use of a tensioner device 38; 40 provides for CED tension always being maintained on the reel 29.

The tensioner device 38; 40 is associated with a tensioner drive motor 38′; 40′ enabling the tensioner to move reciprocally in axial direction of the reel along the horizontal part 39′; 41′, and a CED passage length counter 38″; 40″.

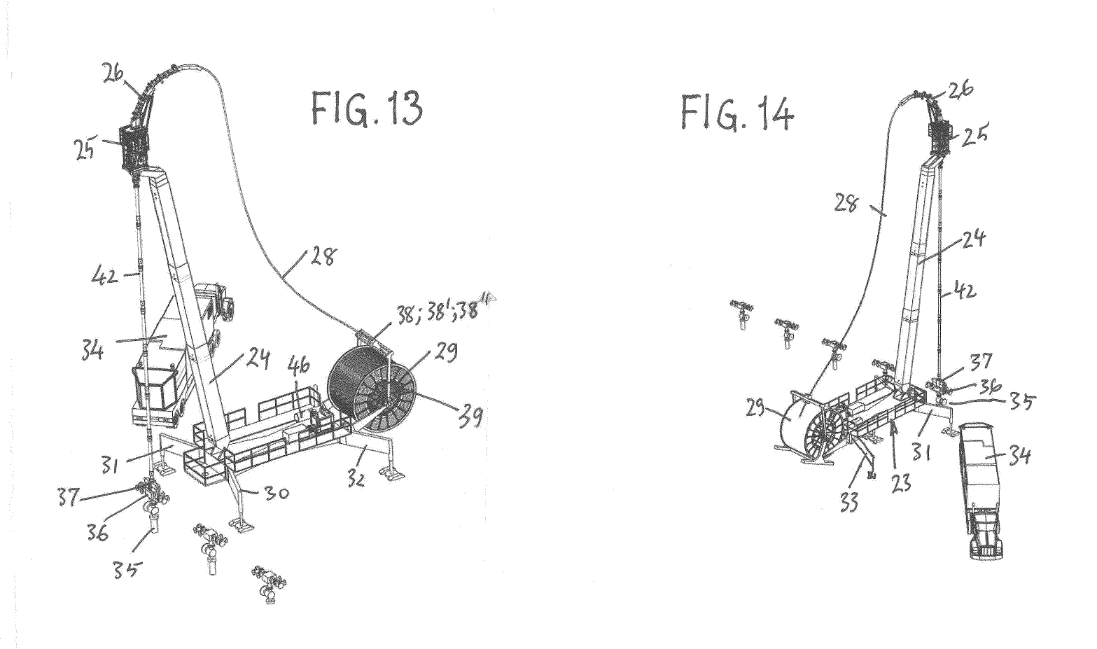

A lubricator section through which the CED is passed is denoted as 42 on FIGS. 13-15. Its function is conventional and does not form a part of the present invention.

The feet 30′-33′ of the platform legs or outriggers 30-33 define corners of a polygon 43 on a ground surface 44 on which the work platform 23 is located by means of the legs/outriggers 30-33.

A centre of gravity of system equipment, composed of the work platform 23, the mast 24, the conveyor device/injector head/arch 25; 26, the CED 28 between the reel 29, the conveyor device/injector head/arch 25; 26 and the well 35, the reel 29, and CED on the reel 29, is located inside the perimeter of the polygon.

An outer location of the legs or outriggers 30-33 define a movement circle 45 about the centre of which the platform 23 can be rotated using the feet 30′-33′ at the outer location which are configured for both walking and support of the work platform 23. All movements of the feet 30′-33′ as regards lifting, transverse moves, longitudinal moves, and/or turning are suitably sequenced and coordinated by a control system suitably located in the control vehicle, although portable remote control devices may be used. The pad walking system is fail safe, as in case of hydraulic pressure loss, the pads will lower to a mechanical end stop. The pad walker rests on mechanical locks while in an intervention mode. Normally, an operator simply set distance and direction to travel. Walking travel speed is suitably approximately 1 meter/minute. The control system ensures that the platform (“skid”) is level during a pad walk. The platform related part of the system may be operated from a safe distance.

A hydraulic power unit 46 is located on the platform In summary, there is provided pad well operation equipment system with a work platform 23, which
can walk from well 35 to well 35;
can walk from well 35 to well 35 with the reel 29 attached and the mast 24 erected;
can walk from well 35 to well 35 with the reel 29 attached and the mast 24 erected, complete assembled with BOP 37, lubricators 42, coil/CED 28 and down hole tools (not shown on the drawings) assembled on to the CED (e.g. coil);
can move in X, Y axis and also rotate about Z axis;
can lift itself off a “lowboy” trailer 21;
can store the BOP 37 while moving;
can lift a full reel 29 off a trailer 21;
has a telescopic mast 24 which can tilt from stored position, to straight up and to well center position;
has the injector head (conveyor device) 25; 26 mounted on top (free end) of the telescopic mast 24;
can use an optimized mast 24 instead of a conventional intervention crane.

Upon movement from one well 35 to a next one, the mast 24 is used to lift and retract injector head 25, the lubricators 42 and the BOP 37 off wellhead 36. Toolstring, e.g. the CED 28, can stay inside lubricators when moving the work platform to the next well. However, in order not to damage the BOP 37, it is—as mentioned before—placed on the platform part 23″′ during the movement until the location for the work platform 23 is reached for a next well to be operated. In movement, the “Pad Walker” or platform 23 mainly moves sideways. When at next pad well, the process is reversed.

On current CED/coil/tubing units the injector head, reel and operations control cabin are placed on the same trailer. With road restrictions of approx. 100 metric tons, that implies that the amount of CED on the reel is severely restricted.

As described, the inventive system provides for the reel 29 to be transported as a separate load and without the necessity of a tailored trailer, such as the trailer 16, to stay at the well site during well operations, implying that the reel 29 can carry a much longer CED/coil 28 for a given truck/trailer load.

Further, the invention provides for a more efficient pad drilling operation, with a faster move from well to well. Also, there is no need for service companies to invest in expensive custom made trailers, as service companies can rent “lowboy” trailers as required.

The invention also implies less crane capacity required, and provides for being able to service longer wells than other existing equipment, simply due a much longer CED or a CED with larger diameter supplied to the well site on the reel 29.

The pad type coiled tubing/CED unit is a unit for coiled tubing/CED intervention on pad with several wells. It can be rigged up on a well site in a matter of hours and stay on site for 6 months or more.

The present invention provides for a skid-based coiled tubing/CED well intervention unit for pad drilling, creating a high efficient multi-well pad coiled tubing/CED unit, avoiding swinging loads over nearby wells, ensuring compact footprint to stay on one side of the wells, and enabling to serve pads of unlimited lengths. There is theoretically no limit to distance between wells or number of wells.

The mast 24 tilts the injector head 25 to line up with CED (tubing) 28. CED 28 is the entered into the injector head 25, the mast 24 is erected to an upright position, and the injector head is tilted, ready to add lubricators 42 or toolstring.

Essentially, a rigging mode is selected. The guide arch 26 is positioned for loading of CED. The injector head 25 is rotated to accept CED (coil). Tubing/CED tensioner 38; 40 injects CED (coil) into injector head 25 and the injector head slowly moves the CED/tubing. The mast 24 is raised while CED reel pays out CED thereon. The mast 24 is suitably telescopically extended while reel 29 pays out.

The technical terms used in the present description are to be interpreted in the broadest sense of the respective terms and includes all similar items in the field, known by other terms, as may be clear to persons skilled in the art.

Restriction/limitation, if any, referred to in the specification, is solely by way of example and understanding the present invention.

Configurations of structural elements which do not affect the overall operation of the system are to be construed as merely technical equivalents within the scope of the present invention.

1. A well operation method for handling a continuous elongate device (CED), such as e.g. coiled tubing, rod, wire or wireline, to be inserted into and retracted from a well, the method comprising:
transporting to a well site by a first trailer a movable work platform having a tiltable mast and a CED conveyor apparatus linked to a free end of the mast;
deploying at least four legs or outriggers out from a platform circumference;
lifting the work platform up from and off engagement with the first trailer by means of said legs or outriggers;
moving the trailer away from the work platform;
transporting a CED reel to a rear end of the work platform by means of a second trailer;
causing arms at a rear end of the work platform to engage the CED reel;
lifting the CED reel off the trailer; and
bringing the CED in engagement with the conveyor apparatus and a lubricator string, wellhead and a well.

2. The method of claim 1, wherein the work platform when resting on its legs or outriggers on a land surface is moved from one pad well to an adjacent pad well by means of walking beams system feet movement being available in any one of its sideways directions, its longitudinal directions and its rotation about a rotation axis commonly defined by the legs or outriggers.

3. The method of claim 1, wherein feet of the platform legs or outriggers define corners of a polygon on a ground surface on which the work platform is located by means of the legs or outriggers, and wherein centre of gravity of system equipment, composed of the work platform, the mast, the conveyor device, the CED between the reel, the conveyor device and the well, the reel, and CED on the reel, is located inside the perimeter of the polygon.

4. A well operation equipment system for handling a continuous elongate device (CED) to be inserted into and retracted from a well, the system comprising:
a movable work platform;
a tiltable mast which is configured to extend or be extendable with inclination up from a front region of the work platform; and
a CED conveyor apparatus linkable or linked to a free end of the mast;
wherein the work platform has from a rear region thereof a pair of rearwards extending CED reel lifter and reel retainer arms configured to handle a CED reel; and
wherein the work platform has at least four legs or outriggers deployable out from its circumference.

5. The system of claim 4, wherein the work platform is configured to be releasable held and be transportable in its longitudinal directions to and from a well site by means of a trailer, and wherein the work platform is able to be lifted up from and off engagement or down into engagement with the trailer (by means of said legs or outriggers.

6. The system of claim 4, wherein the work platform when resting on its legs or outriggers on a land surface is movable from one pad well to an adjacent pad well by means of walking beams system feet, movement being available in any one of its sideways directions, its longitudinal directions and its rotation about a rotation axis commonly defined by the legs or outriggers.

7. The system of claim 4, wherein the CED reel is movable to a platform location by means of a trailer on which the reel can rest, and wherein the CED reel is configured to be moved from engagement with the trailer and into engagement with the reel lifter and retainer arms on the platform.

8. The system of claim 4, wherein the CED reel is movable into engagement with said arms by means of a trailer on which the reel can rest by means of reel legs and wherein the CED reel is configured to be lifted off the trailer by lifting action from said reel lifter and retainer arms using hydraulic cylinders located on the platform and acting on the arms.

9. The system of claim 4, wherein the CED reel is movable into engagement with said arms by means of a trailer on which the reel can rest by means of reel legs, and wherein the CED reel is configured to be lifted off the trailer by lifting action from said reel lifter and retainer arms using lifting power from hydraulic cylinders acting between an outer location of the legs or outriggers and their feet.

10. The system of claim 4, wherein a CED tensioner device is located above the reel or at a rear end of the platform adjacent a forward region of the reel and above highest level of the reel.

11. The system of claim 10, wherein the tensioner device is associated with a tensioner drive motor enabling the tensioner to move reciprocally in axial direction of the reel, and a CED passage length counter.

12. The system of claim 4, wherein feet of the platform legs or outriggers define corners of a polygon on a ground surface on which the work platform is located by means of the legs or outriggers, and wherein centre of gravity of system equipment, composed of the work platform, the mast, the conveyor device, the CED between the reel, the conveyor device and the well, the reel, and CED on the reel, is located inside the perimeter of the polygon.

13. The system of claim 4, wherein an outer location of the legs or outriggers define a movement circle about the centre of which the platform can be rotated, the feet at the outer location being configured for both walking and support of the work platform.
